(19) United States
(12) Patent Application Publication
(10) Pub. No.: US 2026/0114385 A1
(43) Pub. Date: Apr. 30, 2026

(54) PROTECTIVE BARRIER CONSTRUCTION PATTERN AND PLANT SPECIES ALLOCATION METHOD FOR OASIS IN ARID REGION

(71) Applicant: Xinjiang Institute of Ecology and Geography, Chinese Academy of Sciences, Urumqi (CN)

(72) Inventors: Guojun LIU, Urumqi (CN); Shengyu LI, Urumqi (CN); Zhibin ZHOU, Urumqi (CN); Jinglong FAN, Urumqi (CN); Chunwu SONG, Urumqi (CN); Jianxin ZHANG, Shihezi (CN)

(21) Appl. No.: 18/988,929

(22) Filed: Dec. 20, 2024

(30) Foreign Application Priority Data
Oct. 24, 2024 (CN) 202411494652.5

(51) Int. Cl. A01G 9/28; A01G 13/23

(52) U.S. Cl. CPC A01G 9/28; A01G 13/23

(57) ABSTRACT

Disclosed in the present disclosure is a protective barrier construction pattern and plant species allocation method for an oasis in an arid region, relating to the field of ecological protection for oases in arid regions. A protective barrier is arranged according to characteristics of an oasis structure in the arid region, and suitable arbors, shrubs and herbaceous plants are allocated according to habits, uses and morphological characteristics of plants and functional differences of different plants, including constructing a photovoltaic+mechanical sand fixation+shrub and herbaceous plant type sand-blocking belt at an edge of desert, setting up a basal windbreak forest at the junction between the desert and the oasis, carrying out forest net construction in a farmland area inside the oasis, and carrying out greening and beautification on a periphery and an interior of a residential area.

### TECHNICAL FIELD

The present disclosure relates to the technical field of ecological protection for oases in arid regions, and in particular to a protective barrier construction pattern and plant species allocation method for an oasis in an arid region.

### BACKGROUND

Oases in arid regions are fragile and unique ecosystems. They are often surrounded by desert and vulnerable to sandstorm invasion and desertification expansion. In these areas, water resources are scarce, and vegetation is scarce, and thus ecosystem restoration and protection face great challenges. Although an existing ecological protection method has achieved certain results, the method still has major limitations when faced with problems such as desert expansion, sandstorm invasion, and water shortage. Most of traditional desertification control methods rely on single mechanical sand fixation, shrub planting or water-intensive irrigation measures, but these methods often lack versatility and cannot fundamentally solve the problem of desertification.

In addition, most of existing protective systems for oases lack systematicness and integrity, and a protective effect is difficult to sustain. Single vegetation species and irrigation methods lead to insufficient diversity and stability of the ecosystem, a slow ecological recovery speed, and unsatisfactory protective effect in the face of extreme weather conditions such as dry hot wind, sandstorm and other natural disasters. Moreover, it is difficult to achieve the balance between economic benefits and ecological protection. Many protective projects only pay attention to environmental protection, but ignore the sustainable development of regional economy, resulting in long-term investment and high maintenance costs.

Therefore, in view of complex environmental conditions of the oases in the arid regions, it is urgent to have a comprehensive and multi-level ecological protective barrier construction method, so as to effectively prevent expansion of desertification and improve the ecological environment, give consideration to efficient use of water resources and sustainable development of the regional economy, and achieve a win-win situation of ecology and economy.

### SUMMARY

Aiming at the defects of the prior art, the present disclosure provides a protective barrier construction pattern and plant species allocation method for an oasis in an arid region. According to the method, a sustainable ecological protective system is constructed through multi-level vegetation allocation and efficient utilization of water resources in an oasis of an arid region, so as to effectively prevent expansion of desertification and promote regional economic development.

In order to achieve the above objective, implementation is carried out by the present disclosure through the following technical solutions: a protective barrier construction pattern and plant species allocation method for an oasis in an arid region. A protective barrier is arranged according to characteristics of an oasis structure in the arid region, and suitable arbors, shrubs and herbaceous plants are allocated according to habits, uses and morphological characteristics of plants and functional differences of different plants, specifically including the following four protective systems:
(1) constructing a photovoltaic+mechanical sand fixation+shrub and herbaceous plant type sand-blocking belt at an edge of desert, where for mechanical desertification control, sand barriers and straw checkerboard barriers are used for sand fixation, photovoltaic desertification control is employed in areas suitable for photovoltaic power generation, sand enclosing for grass cultivation and reforestation is carried out in areas suitable for vegetation growth, native shrubs are mainly selected, and artificial irrigation is not required for planted tree species;
(2) setting up a basal windbreak forest at the junction between the desert and the oasis, where tree species are native tall trees;
(3) carrying out forest net construction in a farmland area inside the oasis to form a farmland shelter belt; and
(4) carrying out greening and beautification on a periphery and an interior of a residential area, where a residential greening protective forest is planted on the periphery, a road forest, a scenic forest and a green belt are set up in the residential area, an economic forest and flowering shrubs are planted in courtyards of farmers, tall trees are planted in the courtyard at spacing of 4.0 m×4.0 m, and the shrubs are planted at spacing 1.0 m×1.0 m.

Optionally, in the photovoltaic+mechanical sand fixation+shrub and herbaceous plant type sand-blocking belt at the edge of the desert, shrub species include Tamarix chinensis, Hedysarum scoparium, Caragana korshinskii, Haloxylon ammodendron, Haloxylon persicum, Calligonum mongolicum, Halostachys nodiflora, Halocnemum strobilaceum, and Lycium barbarum, and the herbaceous plants include Alhagi sparsifolia, Apocynum venetum, Agropyron cristatum, Bromus inermis, Dactylis glomerata, and Krascheninnikovia ceratoides.

Planting of the shrub and herbaceous plant type sand-blocking belt specifically includes:
(1) a shrub planting method is non-irrigation afforestation, and plant spacing during planting is 1.0 m×6.0 m;
(2) the herbaceous plants are planted in the way of enclosing sand for grass cultivation, and a planting density is 3-5 plants per square meter; and
(3) for the areas suitable for photovoltaic power generation, the shrubs and the herbaceous plants are planted under a support of a photovoltaic panel, and a shading effect of the photovoltaic panel is combined with mechanical desertification control to improve a survival rate of vegetation.

Optionally, in the photovoltaic+mechanical sand fixation+shrub and herbaceous plant type sand-blocking belt at the edge of the desert, selected shrubs include plants with an ecological protection function and economic value, including L. barbarum, H. ammodendron inoculated with Phaseolus multiflorus, and T. chinensis inoculated with P. multiflorus, plant spacing during shrub planting is 1.0 m×6.0 m, a non-irrigation planting mode is employed, and native plants are mainly selected.

Optionally, main tree species of the basal windbreak forest belt are Siberian elm, Elaeagnus angustifolia, Populus euphratica and poplar, an arrangement mode is a triangular pattern, plant spacing is 2.0 m×2.0 m, and a width is 4-10 m.

Optionally, main tree species in the farmland shelter belt are Siberian elm, E. angustifolia, P. euphratica, poplar and Fraxinus chinensis, and are arranged in a triangular pattern, plant spacing is 2.0 m×2.0 m, and plants are planted in two rows.

Optionally, the farmland shelter belt further includes a cash crop planting garden, and planted tree species for the economic forest include grapes, apple trees, peach trees, seabuckthorn and Xanthoceras sorbifolia.

Optionally, the tall trees in the periphery of the residential area include Populus bolleana, Populus alba, Juglans nigra, F. chinensis, Siberian elm and Pinus sylvestris, plants are planted in two rows and in a triangular pattern, and plant spacing is 2.0 m×2.0 m.

Optionally, the greening tree species on streets and alleys in the residential area include Ulmus pumila, Robinia pseudoacacia, Quercus robur, Fraxinus rhynchophylla, Fraxinus bungeana, Amygdalus communis, Armeniaca sibirica, Amorpha fruticosa, Prunus triloba, ruby begonia and X. sorbifolia, and plant spacing is 2.0 m×4.0 m.

Optionally, the economic forest tree species in the courtyards of the residential area include peach trees, apricot trees, apple trees, plums, mulberry trees, hawthorn trees, cherry trees, raspberries and grapes, and plant spacing is 4.0 m×4.0 m.

Optionally, the greening and beautification shrubs in the courtyards of the residential area include Rosa xanthina, Sorbaria sorbifolia, Prunus triloba, Syringa oblata, Prunus ceraifera, Rosa chinensis, Rosa rugosa, Amygdalus communis, Berberis thunbergii, peony, Cornus alba and Parthenocissus quinquefolia. They are planted in rows or in a scattered manner, and plant spacing is 1.0 m×1.0 m.

The present disclosure provides the protective barrier construction pattern and plant species allocation method for an oasis in an arid region. The beneficial effects are achieved as follows:

First, according to the present disclosure, the protective barrier system for the oasis is con structured, such that further expansion of desertification can be effectively controlled. The sand-blocking belt combining photovoltaic desertification control and mechanical desertification control as well as shrubs and herbaceous plants forms a multi-level sand-fixation barrier. The multi-level sand-fixation barrier prevents erosion of moving sand dunes, solidifies a surface layer of sand and reduces sandstorm activities. This systematic desertification control method not only improves the capacity of wind prevention and sand fixation, but also provides a more stable ecological environment for the desert frontier. The application of the native plants, such as H. ammodendron and T. chinensis, adapts to the local extreme environment, and these plants can grow without irrigation, making the protective system sustainable.

Second, according to the present disclosure, a protective barrier system with highly complex ecological functions is formed through multi-level three-dimensional allocation of the trees, the shrubs and the herbaceous plants. The trees such as P. euphratica and Siberian elm can provide a long-acting sandstorm barrier, the shrubs such as H. ammodendron and C. mongolicum fill gaps in lower layers and enhance the sand-fixation capacity, and the herbaceous plants such as A. sparsifolia and A. venetum further enhance the fixation of soil. The multi-layer vegetation structure can prevent wind and fix sand and provide various ecosystem services, such that the ecosystem is more resilient and stable, and can effectively resist extreme climatic conditions such as sandstorms and droughts.

Third, in the present disclosure, the reality of water resource shortage in the arid region is fully considered, an afforestation technology without irrigation or with a small amount of irrigation is employed, and drought-resistant and saline-alkali-resistant native plants are mainly selected. These plants are able to survive under the extreme drought conditions and absorb moisture from deeper soil layers through well-developed roots. In addition, through the shading effect of a photovoltaic power generation apparatus, water evaporation on the surface is reduced, and the demand for water resources is further reduced. The design of the whole system not only saves precious water resources, but also avoids excessive dependence on artificial irrigation in an ecological restoration process, thus improving the sustainability of the ecological protective system.

Fourth, in the present disclosure, regional microclimate in the arid region is effectively improved through large-scale vegetation restoration. Vegetation of the shelter belt and the shrub and herbaceous plant belt can reduce a surface temperature, reduce water evaporation and increase humidity in the air. With an increase of vegetation coverage, transpiration makes the moisture content in the air increase, thereby promoting an increase of local precipitation. Long-term vegetation coverage can also inhibit surface wind erosion and reduce a frequency of sandstorms, thereby further improving the regional environment and providing more livable climatic conditions for local agriculture and lives of residents.

### BRIEF DESCRIPTION OF THE DRAWINGS

FIG. 1 is a schematic structural diagram of a protective system of the present disclosure.

FIG. 2 is a schematic diagram of a barrier construction pattern for an oasis in an arid region provided in an embodiment of the present disclosure.

### DETAILED DESCRIPTION OF THE EMBODIMENTS

The technical solutions in the embodiments of the present disclosure will be clearly and completely described below with reference to the accompanying drawings in the description of the present disclosure. Obviously, the described embodiments are merely some embodiments rather than all embodiments of the present disclosure. All the other embodiments obtained by those of ordinary skill in the art based on the embodiments in the present disclosure without creative efforts shall fall within the scope of protection of the present disclosure.

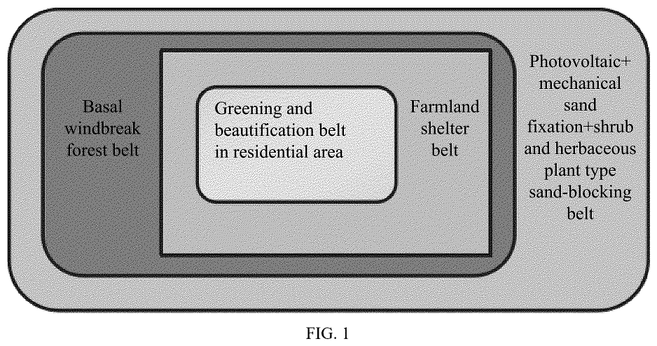

Referring to FIG. 1, the present disclosure provides a protective barrier construction pattern and plant species allocation method for an oasis in an arid region. Aiming at the special ecological environment of the oasis in the arid region, a multi-level and multifunctional ecological protective barrier system is constructed through rational plant species allocations and protective system patterns, so as to realize the organic combination of ecological protection and economic benefits. Implementations of the present disclosure will be described in detail below in combination with various protective systems.

### (1) Photovoltaic+Mechanical Sand Fixation+Shrub and Herbaceous Plant Type Sand-Blocking Belt at Edge of Desert

At the edge zone of the desert, firstly, mechanical desertification control measures, such as setting sand barriers and straw checkerboard barriers, are employed to fix quicksand according to vegetation growth conditions and bare sandy land without vegetation cover. For the areas suitable for photovoltaic power generation, shrubs and herbaceous plants are planted under a support of a photovoltaic panel in combination with a photovoltaic desertification control technology, such that evaporation capacity is reduced through a shading effect of the photovoltaic panel, and a survival rate of vegetation is improved.

Selected shrub species include T. chinensis, H. scoparium, C. korshinskii, H. ammodendron, H. persicum, C. mongolicum, H. nodiflora, H. strobilaceum, L. barbarum and other native plants, these plants have good drought resistance and saline-alkali resistance, and can grow naturally without irrigation. The non-irrigation afforestation mode with plant spacing of 1.0 m×6.0 m is employed for shrub planting, the native plants are mainly selected, and water consumption is reduced.

For the herbaceous plants, the species with strong drought tolerance are selected, such as A. sparsifolia, A. venetum, A. cristatum, B. inermis, Dactylis glomerata, and Krascheninnikovia ceratoides. The planting mode for the herbaceous plants is sand enclosing for grass cultivation, and a planting density is controlled at 3-5 plants per square meter. Thus the vegetation coverage of sandy land is effectively improved, and the sand fixation capacity of the sandy land is further enhanced.

The sand-blocking belt combining photovoltaic desertification control and mechanical desertification control as well as shrubs and herbaceous plants is constructed, can not only effectively prevent the expansion of desertification and reduce the invasion of sandstorms, but also provide additional energy support for ecological restoration in the region by utilizing solar energy resources, and further improves the ecological and economic benefits of the protective system.

### (2) Basal Windbreak Forest Belt

A basal windbreak forest is constructed at the junction between the desert and the oasis, and the main function is to block quicksand, reduce a wind speed and reduce the threat of the sandstorms to the oasis. The construction of basal windbreak forest is based on the principle of “protection against harm”, and tall trees are selected as the main protective tree species.

The tree species of the basal windbreak forest belt include Siberian elm, E. angustifolia, P. euphratica and poplar, all are native trees in the arid region, adapt to a drought and saline environment, and have good stress resistance and durability. The trees are arranged in a triangular pattern, plant spacing is 2.0 m×2.0 m, and a width of the basal windbreak forest is 4-10 m, so as to form a dense forest belt structure, thereby effectively reducing a wind speed and reducing invasion intensity of the sandstorms.

The construction of the basal windbreak forest belt not only plays the role in wind resistance and sand fixation, but also has a certain adjustment effect on regional microclimate, especially in the edge of the oasis, and can prevent the direct threat of the sandstorms to farmland and a residential area.

### (3) Farmland Shelter Belt

Forest net construction is carried out in a farmland area inside the oasis to form a farmland shelter belt. The farmland shelter belt is mainly used for protecting crops from sandstorms, preventing soil erosion and improving farmland productivity.

Main tree species in the farmland shelter belt are Siberian elm, E. angustifolia, P. euphratica, poplar and F. chinensis. The arrangement mode is a triangular pattern, plant spacing is 2.0 m×2.0 m, and trees are planted in two rows. The shelter belt not only plays the role in wind prevention and sand fixation, but also can reduce the loss of farmland soil through a soil fixation function of roots. Economic forest planting, such as grapes, apple trees, peach trees, seabuckthorn and X. sorbifolia, can also be introduced into the shelter belt to form a comprehensive protective system that provides economic benefits while enhancing a protective effect.

For a garden for planting cash crops, water and fertilizer resources shall be reasonably allocated according to local climatic conditions and soil characteristics. The shelter belt is combined with the cash crops, and thus the farmland is protected, and the economic sustainability of the region is enhanced.

### (4) Greening and Beautification in Residential Area

Greening and beautification construction is carried out on a periphery and an interior of the residential area, and is mainly used for improving the living environment of residents, reducing damage of sandstorms, and improving the life quality of the residents.

A residential greening protective forest is planted on the periphery of the residential area, and main tree species include P. bolleana, P. alba, J. nigra, F. chinensis, Siberian elm and P. sylvestris. The trees are arranged in a triangular pattern, plant spacing is 2.0 m×2.0 m, and trees are planted in two rows, so as to form the protective forest mainly including tall trees, thereby playing the role in reducing sandstorms and improving the air quality.

A road forest, a scenic forest and a green belt are set up in the residential area, the greening tree species including U. pumila, R. pseudoacacia, Q. robur, F. rhynchophylla, F. bungeana, A. communis, A. sibirica, A. fruticosa, P. triloba, ruby begonia and X. sorbifolia are planted with plant spacing of 2.0 m×4.0 m, so as to construct a good ecological greening environment, thereby enhancing the living comfort of the residents.

An economic forest including peach trees, apricot trees, apple trees, plums, mulberry trees, hawthorn trees, cherry trees, raspberries and grapes are planted in the courtyards of farmers, plant spacing is 4.0 m×4.0 m, and shade plants can also be planted under the trees. Greening and beautification shrubs in the courtyards including Rosa xanthina, Sorbaria sorbifolia, Prunus triloba, Syringa oblata, Prunus ceraifera, Rosa chinensis, Rosa rugosa, Amygdalus communis, Berberis thunbergii, peony, Cornus alba and Parthenocissus quinquefolia are planted with plant spacing of 1.0 m×1.0 m, can not only beautify the environment of the courtyard, but also improve economic benefits.

Through this multi-level greening and beautification system, the environment in the residential area has been greatly improved, the invasion of the sandstorms has been effectively controlled, and the living comfort and economic income of the residents have been improved.

Through the method of the present disclosure, the ecological protective barrier for the oasis in the arid region is systematically strengthened, various plants are reasonably allocated according to the ecological functions of the plants, and economic benefits and social benefits are considered while ecological protection is realized. The combination of photovoltaic and mechanical desertification control, especially at the edge of the desert, not only prevents the expansion of desertification, but also brings sustainable energy supplies to the region.

The construction of the basal windbreak forest belt and the farmland shelter belt significantly reduces the impact of the sandstorms on the oasis agriculture and lives of the residents, and improves land productivity. The greening and beautification measures in the residential area not only improve the environmental quality, but also increase a planting area of the cash crops, bringing a stable source of income for the local residents.

Generally speaking, the multifunctional protective barrier system realizes the dual goals of ecological protection and regional economic development of the oasis, and has a remarkable effect on improving the ecological environment of the oasis in the arid region.

In order to understand the present disclosure better, detailed description is made below with reference to particular embodiments.

### Embodiment

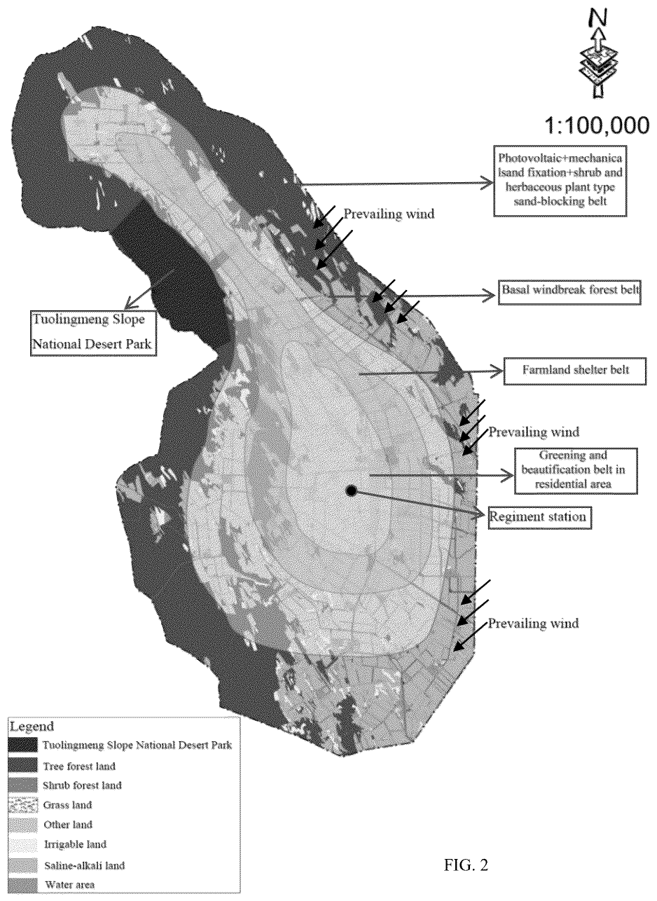

As shown in FIG. 2, the present disclosure provides a protective barrier construction pattern and plant species allocation method for an oasis in an arid region. The method is applicable to a regiment farm of the Corps, where the regiment farm of the Corps is located at the southwest edge of the Junggar Basin, the lower reaches of Manas River irrigation area, and the administrative area is within Manas County. The regiment farm is located at the junction zone between alluvial lake plain in front of Tianshan Mountain and the southern edge of Gurbantunggut Desert, is surrounded by sand on three sides in the east, west and north, in an ox horn shape, extends into the hinterland of the Gurbantunggut Desert by 70 kilometers, and is known as “Sand Sea Peninsula” with an extremely fragile ecological environment. Geographical coordinates are 44°52′64″-45° 12′09″ north latitude and 85° 52′33″-86° 10′46″ east longitude.

The regiment farm of the Corps is located in the hinterland of the Eurasia, belongs to temperate continental arid climate, and has long sunshine hours, cold winter and hot summer, great difference in temperatures between day and night, and sufficient light and heat resources. An annual average temperature is 6.1° C., an annual average accumulated temperature greater than or equal to 10° C. is 3900° C., and annual sunshine hours are 2318-2732 hours. Rainfall is scarce, evaporation is strong, annual average precipitation is about 139 mm, annual average evaporation capacity is 1945 mm, and an evaporation to precipitation ratio is 16:1. A frost-free period is 147-191 days. An average depth of permafrost is 1 m. Strong winds often occur in April and May, dry and hot winds in June and July, with an annual average of 14.9 days for strong winds above grade 8, and northwest winds prevail. Main disaster weather is strong winds, hail, dry hot winds and frost.

The regiment farm is surrounded by sand on three sides in the east, west and north, and the ecological environment is extremely fragile. In order to cope with the severe environmental problems faced by the regiment farm, the present disclosure constructs a multi-level protective system suitable for local ecological conditions by reasonably selecting trees, shrubs and herbaceous plants.

### 1. Photovoltaic Desertification Control+Mechanical Desertification Control+Shrub and Herbaceous Plant Type Sand-Blocking Belt

At an edge zone of desert on a periphery of the regiment farm, firstly, mechanical desertification control is carried out on bare sandy land without vegetation cover, and quicksand is fixed by setting sand barriers and straw checkerboard barriers. For the areas suitable for photovoltaic power generation, a photovoltaic panel is arranged on sand in combination with a photovoltaic desertification control technology, and shrubs and herbaceous plants are planted under the photovoltaic panel. A surface temperature can be reduced through a shading effect of the photovoltaic panel, such that water evaporation is reduced, and a survival rate of vegetation is improved.

Selected shrubs include the native plants such as T. chinensis, H. ammodendron, H. persicum, and C. mongolicum, and these plants are drought-resistant and saline-alkali-resistant and can adapt to the extreme environment in the desert. A specific planting mode is as follows: the T. chinensis is planted in the places with shallow groundwater, the H. ammodendron is planted among sand dunes, the H. persicum is planted at tops of the sand dunes, and the C. mongolicum is planted at bottoms and to of moving sand dunes. Plant spacing during planting is 2.5 m×3 m, a density is 1333 plants/hectare, and the planting mode with a low density and no irrigation is employed.

The herbaceous plants with strong drought resistance are selected, such as A. sparsifolia, A. venetum and Karelinia caspica. These plants are planted in the sand barriers and straw checkerboard barriers to stabilize the sand and prevent wind erosion. These plants not only help fix sand, but also provide habitat for wildlife.

### 2. Basal Windbreak Forest Belt

A large basal windbreak forest is constructed at the junction between the desert on the periphery of the regiment farm and the oasis, and main tree species are native tall trees, such as Siberian elm, E. angustifolia, P. euphratica and poplar. These tree species have good sandstorm resistance and drought resistance and can effectively reduce a wind speed and block invasion of the sandstorms to the oasis.

The trees in the basal windbreak forest belt are arranged in a triangular pattern, plant spacing is 2.0 m×2.0 m, and a width of the forest belt is 4-10 m. Existence of basal windbreak forest can not only control quicksand, but also improve local climate conditions and reduce the threat of the sandstorms to farmland and a residential area.

### 3. Farmland Shelter Belt

Forest net construction is carried out in a farmland area inside the regiment farm to form a farmland shelter belt, and main tree species include Siberian elm, E. angustifolia, P. euphratica, poplar and F. chinensis. The arrangement mode is also a triangular pattern, plant spacing is 2.0 m×2.0 m, and a shelter belt with two rows of trees is formed.

The shelter belt further includes a planting garden for cash crops, and an economic forest suitable for local climate are planted, such as grapes, seabuckthorn and Xanthoceras sorbifolia. These cash crops can not only provides additional income for local farmers, but also can grow vigorously under protection of the shelter belt, thereby improving economic benefits.

### 4. Greening and Beautification Belt in Residential Area

A residential greening protective forest belt is set on a periphery and an interior of the residential area, and tall trees, such as J. nigra, F. chinensis, Siberian elm and P. sylvestris are planted with plant spacing of 2.0 m×2.0 m in two rows. Green belts are set on roads and public places in the residential area, tree species include U. pumila, F. rhynchophylla, F. bungeana, P. triloba, P. triloba, ruby begonia and X. sorbifolia, and plant spacing is 2.0 m×4.0 m.

Economic forest tree species are planted in courtyards of the farmers, including peach trees, apricot trees, apple trees, mulberry trees, hawthorn trees, raspberries and grapes, and plant spacing is 4.0 m×4.0 m. Flowering shrubs are also planted in the courtyards, such as R. xanthina, S. sorbifolia, P. triloba, S. oblata, R. chinensis, and R. rugosa, and plant spacing is 1.0 m×1.0 m. They not only beautify the environment, but also improve income of the residents.

Through the implementation solution of the present disclosure, the ecological environment of the regiment farm of the Corps is obviously improved. The sand-blocking belt on the periphery of the oasis effectively restrains the expansion of desertification, and the basal windbreak forest belt and the farmland shelter belt greatly reduce the threat of the sandstorms to farmland and the residential area. Greening and beautification measures in the residential area have improved the living environment and increased the economic income.

According to statistics from Mosuowan Meteorological Station, the annual total precipitation increases from 117.7 mm to 147.4 mm, the annual average humidity increases from 60.5% to 61.5%, the number of sandstorm days decreases from 20.1 days to 7.5 days, the number of raising sand days decreases from 22.4 days to 11.4 days, and the evaporation capacity decreases from 2039 mm to 1887.1 mm. These changes show that the protective system has achieved remarkable results in improving the ecological environment of the regiment farm and reducing the desertification process.

In addition, the habitat of the wildlife has been effectively restored, and wild animals such as goshawks, hares, yellow sheep and pheasants have not been seen for many years but frequently appear around the regiment farm, indicating that the biodiversity of the ecosystem has also been enhanced.

Through the protective barrier construction of the present disclosure, the regiment farm of the Corps realizes a win-win situation of ecological protection and economic benefits, and therefore, wide application value is achieved.

Although the embodiments of the present disclosure have been illustrated and described, it should be understood that those of ordinary skill in the art may make various changes, modifications, replacements and variations to these embodiments without departing from the principle and spirit of the present disclosure, and the scope of the present disclosure is limited by the appended claims and their legal equivalents.

1. A protective barrier construction pattern and plant species allocation method for an oasis in an arid region, wherein a protective barrier is arranged according to characteristics of an oasis structure in the arid region, and suitable arbors, shrubs and herbaceous plants are allocated according to habits, uses and morphological characteristics of plants and functional differences of different plants, specifically comprising the following four protective systems:
(1) constructing a photovoltaic+mechanical sand fixation+shrub and herbaceous plant type sand-blocking belt at an edge of desert, wherein for mechanical desertification control, sand barriers and straw checkerboard barriers are used for sand fixation, photovoltaic desertification control is employed in areas suitable for photovoltaic power generation, sand enclosing for grass cultivation and reforestation is carried out in areas suitable for vegetation growth, native shrubs are mainly selected, and artificial irrigation is not required for planted tree species;
(2) setting up a basal windbreak forest at the junction between the desert and the oasis, wherein tree species are native tall trees;
(3) carrying out forest net construction in a farmland area inside the oasis to form a farmland shelter belt; and
(4) carrying out greening and beautification on a periphery and an interior of a residential area, wherein a residential greening protective forest is planted on the periphery, a road forest, a scenic forest and a green belt are set up in the residential area, an economic forest and flowering shrubs are planted in courtyards of farmers, tall trees are planted in the courtyard at spacing of 4.0 m×4.0 m, and the shrubs are planted at spacing 1.0 m×1.0 m.

2. The protective barrier construction pattern and plant species allocation method for an oasis in an arid region according to claim 1, wherein in the photovoltaic+mechanical sand fixation+shrub and herbaceous plant type sand-blocking belt at the edge of the desert, shrub species comprise T. chinensis, H. scoparium, C. korshinskii, H. ammodendron, H. persicum, C. mongolicum, H. nodiflora, H. strobilaceum, and L. barbarum, and the herbaceous plants comprise A. sparsifolia, A. venetum, A. cristatum, B. inermis, D. glomerata, and K. ceratoides;
planting of the shrub and herbaceous plant type sand-blocking belt specifically comprises:
(1) a shrub planting method is non-irrigation afforestation, and plant spacing during planting is 1.0 m×6.0 m;
(2) the herbaceous plants are planted in the way of enclosing sand for grass cultivation, and a planting density is 3-5 plants per square meter; and
(3) for the areas suitable for photovoltaic power generation, the shrubs and the herbaceous plants are planted under a support of a photovoltaic panel, and a shading effect of the photovoltaic panel is combined with mechanical desertification control to improve a survival rate of vegetation.

3. The protective barrier construction pattern and plant species allocation method for an oasis in an arid region according to claim 1, wherein in the photovoltaic+mechanical sand fixation+shrub and herbaceous plant type sand-blocking belt at the edge of the desert, selected shrubs comprise plants with an ecological protection function and economic value, comprising L. barbarum, H. ammodendron inoculated with P. multiflorus, and T. chinensis inoculated with P. multiflorus, plant spacing during shrub planting is 1.0 m×6.0 m, a non-irrigation planting mode is employed, and native plants are mainly selected.

4. The protective barrier construction pattern and plant species allocation method for an oasis in an arid region according to claim 1, wherein main tree species of the basal windbreak forest belt are Siberian elm, E. angustifolia, P. euphratica and poplar, an arrangement mode is a triangular pattern, plant spacing is 2.0 m×2.0 m, and a width is 4-10 m.

5. The protective barrier construction pattern and plant species allocation method for an oasis in an arid region according to claim 1, wherein main tree species in the farmland shelter belt are Siberian elm, E. angustifolia, P. euphratica, poplar and F.s chinensis, the arrangement mode is a triangular pattern, plant spacing is 2.0 m×2.0 m, and trees are planted in two rows.

6. The protective barrier construction pattern and plant species allocation method for an oasis in an arid region according to claim 1, wherein the farmland shelter belt further comprises a cash crop planting garden, and planted tree species for the economic forest comprise grapes, apple trees, peach trees, seabuckthorn and X. sorbifolia.

7. The protective barrier construction pattern and plant species allocation method for an oasis in an arid region according to claim 1, wherein the tall trees in the periphery of the residential area comprise P. bolleana, P. alba, J. nigra, F. chinensis, Siberian elm and P. sylvestris, plants are planted in two rows and in a triangular pattern, and plant spacing is 2.0 m×2.0 m.

8. The protective barrier construction pattern and plant species allocation method for an oasis in an arid region according to claim 1, wherein the greening tree species on streets and alleys in the residential area comprise U. pumila, R. pseudoacacia, Q. robur, F. rhynchophylla, F. bungeana, A. communis, A. sibirica, A. fruticosa, P. triloba, ruby begonia and X. sorbifolia, and plant spacing is 2.0 m×4.0 m.

9. The protective barrier construction pattern and plant species allocation method for an oasis in an arid region according to claim 1, wherein the economic forest tree species in the courtyards of the residential area comprise peach trees, apricot trees, apple trees, plums, mulberry trees, hawthorn trees, cherry trees, raspberries and grapes, and plant spacing is 4.0 m×4.0 m.

10. The protective barrier construction pattern and plant species allocation method for an oasis in an arid region according to claim 1, wherein the greening and beautification shrubs in the courtyards of the residential area comprise R. xanthina, S. sorbifolia, P. triloba, S. oblata, P. ceraifera, R. chinensis, R. rugosa, A. communis, B. thunbergii, peony, C. alba and P. quinquefolia, and are planted in rows or in a scattered manner, and plant spacing is 1.0 m×1.0 m.
